(19) United States
(12) Patent Application Publication
(10) Pub. No.: US 2024/0010118 A1
(43) Pub. Date: Jan. 11, 2024

(54) Quick Tie Down Anchor

(71) Applicant: Marcus Hamilton Hunt, Los Angeles, CA (US)

(72) Inventor: Marcus Hamilton Hunt, Los Angeles, CA (US)

(21) Appl. No.: 17/861,010

(22) Filed: Jul. 8, 2022

(51) Int. Cl. B60P 7/08

(52) U.S. Cl. CPC B60P 7/0807

(57) ABSTRACT

An anchor configured to removably secure various objects to a plurality of structures, such as decks, docks, trailers, and fencing, is provided. The anchor comprises a shank extending between an arm and a lashing means, and a locking means disposed along the length of the shank. The locking means may comprise a resilient compression spring that self-adjusts the anchor to secure the arm with a bottom of a selected structure, and a first and second stopper may be provided to compress the selected structure against the arm. The lashing means may rotate about the shank to allow for secure connection of objects in different configurations without compromising security.

### CROSS-REFERENCE TO RELATED APPLICATIONS

This patent application claims the benefit of earlier filed U.S. Provisional Patent Application Ser. No. 63/299,185 filed on 13 Jan. 2022. The entirety of such application is incorporated herein by reference.

### GOVERNMENT CONTRACT

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to a selectively removable tie-down anchor. More specifically, to a selectively removable tie-down anchor capable of securing to existing openings in structures of varying sizes.

### BACKGROUND

Properly securing objects to prevent them from tipping, falling, rolling away, and even becoming projectiles can be essential, as failure to do so in certain contexts so can lead to property damage, injury, or even death to the driver, passengers, and others. For example, failing to secure objects such as ladders and mattresses to trucks or trailers can cause the objects to fall off the truck or trailer, becoming a projectile and creating a hazard on the roads. Further, failing to secure objects such as tables and tents to a deck or porch can allow wind, or, in some circumstances, even wild animals, to carry off or damage the objects. Indeed, gravity alone can cause furniture and other items to dangerously tip if unsecured. However, it is not currently possible to secure possible projectiles to all structures. Indeed, many structures lack sufficient attachment points for safe securement. For example, ropes may be used to secure objects to certain structures using simple knots, such as a trucker's hitch, but its applicability is limited as the knot requires two through openings to receive the rope. Unfortunately, many structures lack the required openings or other points of lashing. In many instances, if they do, these openings often have sharp edges that can fray the rope, causing it to weaken and even break, resulting in unreliable means for securing the objects.

While ratchet straps, such as U.S. Pat. No. 8,370,997 to Wright, have, in some instances, eliminated the need for the through openings required for simple knots, these straps nevertheless require specific attachment locations. Typical ratchet straps have a hook on either end, which can attach to anchor points on a structure. However, not all structures are suitable for connecting the hooks, as they are too narrow, too short, too deep, or the material is too weak to allow a strong connection. Connecting to an unsuitable structure may lead to the hook coming off during use, which creates a heavy projectile that can cause property damage in addition to the possibility of personal and/or property damage that may occur upon release of the unsecured object. Thus, there is a need for an anchor to increase the attachment security of connection means, such as ratchet straps and simple knots.

One proposal to improve connection is U.S. Pat. No. 8,651,784 to Grasso, which provides an attachment device that can be mounted to a surface. However, this proposal is deficient because it requires the permanent mounting of individual connection points, thus limiting the objects that may be securely connected without using additional permanent connection points.

Other proposals, such as U.S. Pat. No. 6,939,095 to Hugg, U.S. Pat. No. 6,799,927 to Wheatley, and U.S. Pat. No. 4,085,684 to McLennan, provide securement mechanisms that offer a plurality of connection points. However, these proposals all require permanently mounting the anchoring mechanism to a surface. While these proposals provide a greater variety of connection points than Gasso, they are nevertheless deficient as the connection points remain in set positions, which limits the placement of any objects for securement. In some instances, this proposal may not accommodate a wide range of differently sized objects depending on the placement of the connection points in their set positions. Further, because the connection sites cannot be moved, objects must be placed in the same location, which, in part, limits the ability to connect multiple objects simultaneously.

Furthermore, none of these proposals provide a movable connection site that utilizes pre-existing gaps, such as gaps in docks, decks, fencing, and floorboards, to create an anchor point. Instead, the proposals require the permanent additions of new connection sites through drilling, welding, or other connection means, permanently altering the structure.

One proposal, WO 2020145475 to Sung, discloses a spring deck peg to allow for the connection of a tent to a deck including a hook for a connection site movable along the deck. However, this disclosure is limited in its use of a body having a loop, which is fixed in relation to the body, preventing connection of an object to the peg from multiple angles. Thus, the connection is limited to directions perpendicular to the deck orientation. Indeed, the Sung hook defines a weak, easily deformable design that is unsuitable for large objects. Further, while Sung fails to teach an adjustment means that comprises both automatic and manual adjustment to allow for an improved connection. Thus, Sung fails to provide a spring deck peg suitable for securing large objects, such as boats and machinery, that permits securement from a multitude of directions.

Thus, although various proposals have been made for different types of connection anchors, none of those in existence combine the characteristics of the present invention. As such, there is a need for a removable quick tie-down anchor that can be securely attached at multiple points.

### SUMMARY

The present disclosure is directed to an anchor operative to provide a movable connection site suitable for use with a plurality of structures. In this disclosure, the anchor may be removably secured to a structure to allow for custom placement and removal of the anchor when not in use.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In accordance with one embodiment, the anchor may comprise a shank and a locking means, wherein the shank has a first end terminating with a lashing means, and a second end terminating with an arm. The locking means may be disposed along the length of the shank between the arm and the lashing means and allow the anchor to engage the plurality of structures comprising varying thicknesses. It is contemplated that the anchor may be removably secured to the structure through an opening in such structure. When in use, the lashing means and the arm will be located on opposite sides of the opening, while the shank traverses the opening. For example, and without limitation, the structure may be a deck, trailer, floorboards, wire mesh, fencing, or other similar structures comprising openings.

In some embodiments, the shank may be rugged, yet flexible to allow for bending when force is applied. The shank may be operative to bend in any direction. Further, the shank may have a range of motion of 90° from normal in any direction. In another embodiment, the shank may be resilient to extend upwards when no force is applied to the shank. For example, and without limitation, the shank may be a cable. The cable may, without limitation, be a metal cable, such as steel, stainless steel, galvanized steel, vinyl coated steel, aluminum, titanium, and copper. A person of ordinary skill in the art will appreciate that the aforementioned examples are provided as examples only, and a wide range of materials may be used.

The lashing means may be any suitable attachment means. For example, the lashing means may be any of a hook, loop, shackle, ring, clip, clasp, eyelet, carabiner, and cleat. In some embodiments, the lashing means may comprise a spring-loaded gate, however, this is not necessary to practice the invention. Indeed, a person of ordinary skill in the art will appreciate that the aforementioned lashing means are provided as examples only and all forms of lashing means may be utilized in the present invention.

In some embodiments, the lashing means may be configured to rotate. For example, the lashing means may operative to rotate three-hundred sixty degrees around an axis. In one embodiment, the axis may be defined by a connection between the shank and lashing means, however, a person of ordinary skill will appreciate that the axis may be located at any point. It is contemplated that allowing the lashing means to rotate may disperse forces acting on the shank and arm when in use and prevent the arm from disengaging with the structure during use. It is further contemplated that the rotation of the lashing means may allow for connection to the lashing means from a plurality of directions. For example, allowing the lashing means to rotate may allow the lashing means to attach to a connection means parallel with the opening in the structure by enabling the lashing means to rotate until it is perpendicular to the opening in the structure.

In another embodiment, the lashing means may be configured to rotate one-hundred eighty degrees along an arc about the first end of the shank. For example, the lashing means may be located at less than about ninety degrees along the arc to secure an object to the structure.

The locking means may comprise an adjustment means and at least one stopper. It is contemplated that the adjustment means may allow the anchor to be removably secured with structures of varying depths. For example, the structure may have a depth of less than about 2 inches, however, a person of ordinary skill will appreciate that other depths, such as less than about 6 inches, 12 inches, or more are contemplated. The adjustment means may, in one embodiment, be a resilient compression spring that surrounds the shank. It is contemplated that in some embodiments the total length of the locking means may be defined by a distance between the lashing means and the arm. In such an embodiment, the free length of the resilient compression spring may be the distance between the lashing means and the arm minus a height of the at least one stopper. In another embodiment, the free length of the resilient compression spring and the at least one stopper may be less than the distance between the lashing means and the arm.

In one embodiment, the at least one stopper may act as a barrier between the adjustment means and the lashing means. In another embodiment, the at least one stopper may act as the barrier between the adjustment means and the arm. In some embodiments, the anchor may comprise two stoppers located on opposing sides of the adjustment means, thus acting as barriers between the adjustment means and the lashing means and the adjustment means and the arm. In some embodiments, the locking means may lock to the structure without the need for manual adjustment, thus minimizing the need to exercise fine motor skills during installation. For example, the adjustment means may be the resilient compression spring, and when a force is applied to the at least one stopper disposed on an end of the resilient compression spring, to compress the resilient compression spring toward the lashing means, the arm and at least a portion of the shank may pass through the opening in the structure. The resilient compression spring may then provide resistance to at least one of the at least one stopper disposed between the resilient compression spring and the arm, the at least one stopper contacting a surface of the structure when in use. Thus, the stopper may prevent movement of the lashing means toward the structure, and the arm may be prevented from moving through the structure, locking the anchor to the structure.

The at least one stopper may be any stopper known in the art, such as a washer, stop crimp, stop spring, and nut. A person of ordinary skill in the art will appreciate the aforementioned stoppers are provided for example only and that any stopper in the art may be used without departing from the invention. In one embodiment, each of the at least one stopper may be the same type of stopper. However, in another embodiment, the at least one stopper may be the different from another of the at least one stopper. As a non-limiting example, a first of the at least one stopper may be a washer, and a second of the at least one stopper may be a stop crimp. It is contemplated that the at least one stopper being the washer may act as the barrier between the locking means and the structure. Additionally, the washer may provide stability when in use by increasing the surface area in contact with the structure when in use. It is further contemplated that the washer may create a uniform surface for the locking means to contact, allowing for engagement with different types of structures. For example, the washer may extend over the opening in the structure, such as gaps in decking, wire fencing, wire mesh flooring, or other objects that comprise openings. In a clarifying example, when the structure is a wire mesh the arm may be aligned to contact a first side of the wire mesh, the shank may extend through any opening of the wire mesh, and the washer may contact a second side of the wire mesh. The washer may extend over the opening of the wire mesh, operative to create an area for uniform contact of the adjustments means on the surface of the structure. In a further example, when the structure is decking, the washer may create a uniform surface to allow for a uniform force to be applied to the adjustment means. Thus, the washer may cover the opening, such as gaps in the decking, to provide the uniform surface even in instances where decking is uneven or missing.

In some embodiments where the at least one stopper may be the stop crimp, it is contemplated that the stop crimp may allow for manual compression of the adjustment means. For example, the stop crimp may be disposed between the adjustment means and the lashing means and may move towards the structure, compressing the adjustment means, when force is applied allowing the anchor to be removed from the structure. Further, in one embodiment, the stop crimp may allow for manual adjustment of the adjustment means.

In one embodiment, the at least one stopper may be the adjustment means itself. For example, the shank may be threaded, and the stopper may be a nut configured to move along a threaded length of the shank. Thus, it will be recognized that a threaded nut may serve as both the adjustment means and the at least one stopper.

The arm may be any means suitable to attach the anchor to the structure. In one embodiment, the arm may be a bar configured to pass through the opening on the structure. However, in other embodiments, the arm may be a rod, beam, or other structural member known in the art. It is contemplated that once the arm passes through the opening, the arm may be rotated to extend across the opening, preventing the arm from passing through the opening again until the arm has been rotated to align with the opening.

In an embodiment, the arm may comprise at least one gripping means configured to engage with the structure to reduce movement of the anchor when secured to the structure. For example, the gripping means may extend off a surface of the arm opposing the structure, thus the gripping means may contact an underside of the structure when secured.

In one embodiment, the gripping means may be at least one spike extending off the surface of the arm that contacts the structure. The at least one spike may be operative to bite into or otherwise engage an under or outside of the structure, or any side of the structure opposite the lashing means. In a further embodiment, the at least one spike may comprise an equal number of spikes on opposite ends of the surface of the arm opposing the structure. For example, and without limitation, the at least one spike may comprise two spikes located on opposite sides of the surface of the arm opposing the relevant surface of structure, the two spikes disposed along a midline of the anchor. In another example, the at least one spike may comprise four spikes, each located proximate to a corner of the surface of the arm opposing the structure. In another embodiment, the gripping means may comprise a grit disposed along the surface of the arm opposing the structure. The grit may provide a rough surface that increases the friction between the structure and the surface of the arm opposing the structure.

Several advantages of this anchor are that it:
a.) creates a movable connection site operable to connect to a plurality of structures;
b.) provides an anchor that is operable without the need for fine motor skills;
c.) is capable of being installed to structures where only one surface of the structure is accessible; and
d.) increases the type of connections means able to be attached to a structure.

It is an object of this invention to provide a movable connection site. It is another object of this invention to provide an anchor connectable to a plurality of structures. It is yet a further object of this invention to provide an anchor that automatically adjusts to a variety of sizes associated with different structures.

It is a further object of this invention to allow for connection of objects located at a variety of positions relative to the anchor. It is still a further object of this invention to create increase the securement of the anchor to the structure by reducing slippage. It is yet another object of this invention to provide a heavy-duty anchor capable of securing cumbersome objects.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 shows a perspective view of an embodiment of the anchor.

FIG. 2 shows an exploded view of an embodiment of the anchor.

FIG. 3 shows a plan view of an embodiment of the anchor.

FIG. 4 shows a bottom view of an embodiment of the anchor when in use.

FIG. 5 shows a top view of an embodiment of the anchor when in use.

The disclosed embodiments may be better understood by referring to the figures in the attached drawings, as provided below. The attached figures are provided as non-limiting examples for providing an enabling description of the method and system claimed. Attention is called to the fact, however, that the appended drawings illustrate only typical embodiments of this invention and are therefore not to be considered as limiting of its scope. One skilled in the art will understand that the invention may be practiced without some of the details included in order to provide a thorough enabling description of such embodiments. Well-known structures and functions have not been shown or described in detail to avoid unnecessarily obscuring the description of the embodiments.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

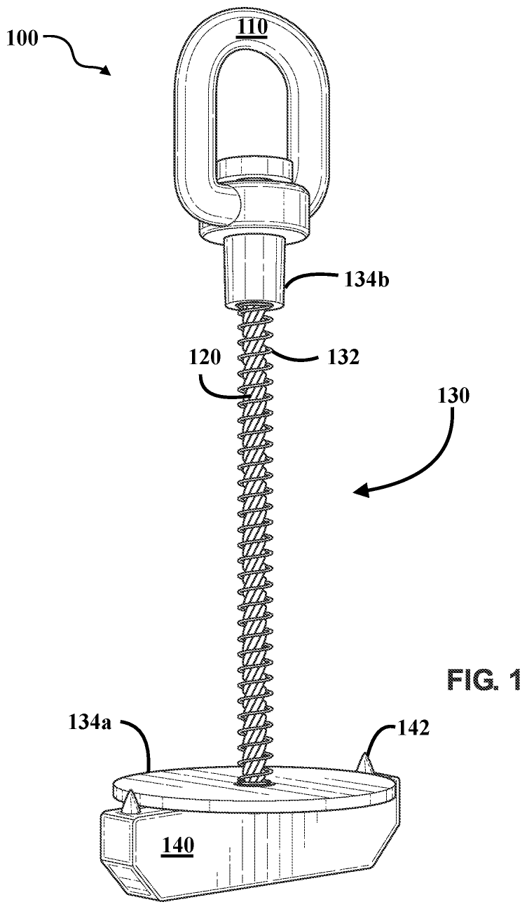

With reference to FIGS. 1-3 an embodiment of an anchor 100 is shown. The anchor 100 comprises a lashing means 110, a shank 120, a locking means 130, and an arm 140. The shank 120 have a first end 122 terminating with the lashing means 110 and a second end 124 terminating with the arm 140. The locking means 130 may be disposed between the first end 122 and the second end 124 along the length of the shank 120.

The lashing means 110 may be any means suitable for allowing connection to the anchor 100. In an exemplary embodiment, the lashing means 110 may be an attachment loop. However, it is contemplated that the lashing means 110 may be a shackle, hook, clip, clasp, eyelet, carabiner, or cleat. A person of ordinary skill in the art will appreciate that the provided lashing means 110 are for example only and any means suitable for lashing may be utilized. Further, the lashing means 110 may comprise a material suitable for connection, such as plastic, steel, stainless steel, galvanized steel, aluminum, titanium, and copper. A person of ordinary skill will appreciate that the aforementioned materials are provided for example only and other materials may be used to practice the invention.

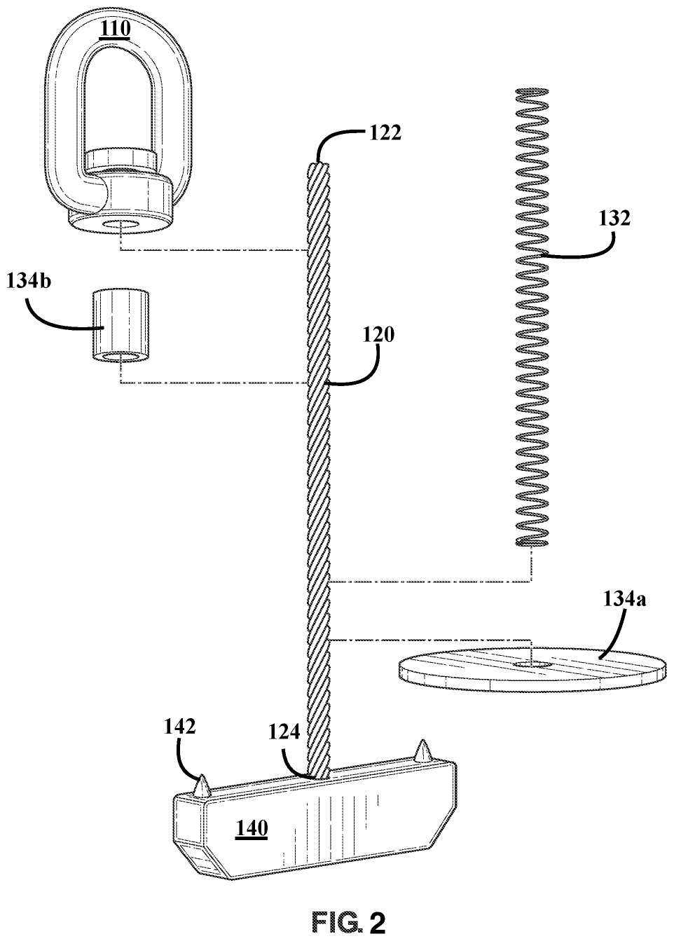

The lashing means 110 may be configured to rotate. With particular reference to FIG. 2, the lashing means 110 may be configured to rotate around the first end 122 of the shank 120. Thus, the location in which the lashing means 110 and the shank 120 connect may create an axis the lashing means 110 rotates around. In one embodiment, the lashing means 110 may rotate 360° around the first end 122 of the shank 120. In another embodiment, the lashing means 110 may rotate 180° in an arc about the first end 122 of the shank 120. It is contemplated that allowing the lashing means 110 to rotate may increase the ability to securely connect with the anchor 100. For example, allowing the lashing means 110 to rotate 360° around the first end 122 may allow for connection of an object (not shown) from different angles, such as an object (not shown) located at a 45° to the anchor 100 while eliminating block twisting of the shank 120. Further, allowing the lashing means 110 to rotate may reduce off-axis loading which a person of ordinary skill will appreciate reduces connection strength. It is further contemplated that allowing the lashing means 110 to rotate may reduce torque acting on the shank 120 and thus may reduce shank 120 deformation.

In a further example, allowing the lashing means 110 to rotate 180° in an arc may allow for connection of objects having different heights. For example, when the object has a substantial height or located adjacent to the opening the lashing means 110 may be located at about 90° to the shank 120. Further, when an object has a slight height or located away from the opening the lashing means 110 may be located at less than about 90° to the shank 120. As a clarifying example only, when the object being secured is a mattress, the lashing means 110 may have a smaller angle on the arc then when the object being secured is a refrigerator. As a further example, and without limitation, the connection means 412 may be a workout resistance band and allowing the lashing means 110 to rotate along the arc may allow the resistance band to be utilized by individuals of varying heights and with various workouts.

As shown in FIG. 5 the lashing means 110 may be configured to allow connection to a connection means 412. In some embodiments, the connection means 412 may allow connection to the lashing means 110 to secure the object (not shown). The connection means 412 may be any suitable means for connection, for example, a rope, strap, or chain terminating in a fastener. In some embodiments, the fastener may be defined by the connection means itself. A person of ordinary skill in the art will appreciate that the provided connection means 412 are for example only and without limitation. Indeed, in some embodiments, the connection means 412 may be the object itself, for example, the workout resistance band, a tarp, or other similar objects known in the art.

The lashing means 110 may be configured to allow for connection of a fastener 414, such as a hook, shackle, carabiner, clip, clasp,—spring-loaded or otherwise—or other forms of fasteners to the connection means 412. It is further contemplated, that the lashing means 110 may be directly connected to the connection means 412, such as, for example, by fashioning an end of the connection means 412 as a knot engaging the lashing means 110. In some embodiments, the lashing means may even comprise a spring-loaded gate, known to those of ordinary skill in the art, in order to securely receive certain types of fasteners and/or objects for securement. A person of ordinary skill in the art will appreciate that the provided forms of connection are for example only and without limitation and that all forms of connection may be used in the present invention.

Returning to FIGS. 1-3, the shank 120 may extend between the arm 140 and the lashing means 110, wherein the lashing means 110 is connected to the first end of the shank 120 and the arm is disposed at the second end of the shank 120. The shank 120 may, for example, be a rugged but flexible cable, rope, chain, or even a rugged and rigid shaft. A person of ordinary skill in the art will appreciate the aforementioned list of shanks is for example only and without limitation. In one exemplary embodiment, the shank 120 may be a metal cable. The cable may be any type of metal, such as and without limitation, stainless steel, galvanized steel, steel, titanium, copper, and aluminum. A person of ordinary skill in the art will appreciate that the provided materials are for example only and appreciate all suitable material may be used. For instance, natural, synthetic, or blended fiber cords may be used as well. The cable may, for example, and without limitation, be from about 0.03125 inch to about 0.5 inch in diameter. In a further embodiment, the cable may be from about 0.0625 inch to about 0.25 inch in diameter. In yet a further embodiment, the cable may be about 0.125 inch in diameter.

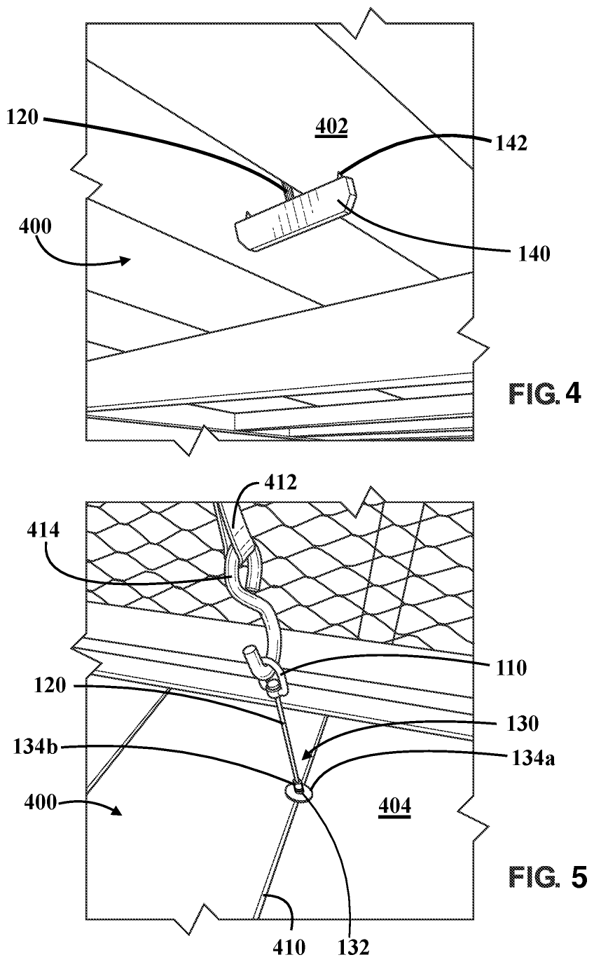

The shank 120 may be any length suitable traverse an opening 410 on a structure 400, as illustrated in FIGS. 4-5. As the anchor 100 may be configured to attach to different types of structures, the shank 120 may have any length suitable to extend through a plurality of openings having different depths. For example, the shank 120 may be from about 1 inch to about 14 inches in length. In a further example, the shank 120 may be from about 3 inches to about 9 inches in length. In yet a further example, the shank 120 may be about 6 inches in length.

In certain exemplary embodiments, the shank 120 may be flexible to allow for bending in any direction when force is applied. Thus, the shank 120 may be operative to bend in the direction of the connection means 412.

In an exemplary embodiment, the shank 120 may be flexible, and the lashing means 110 may be configured to rotate 360° about the first end 122. It is contemplated that such an embodiment may allow for the connection of objects at a variety of heights and locations on the structure 400, increasing the anchor's 100 connectability. For example, when securing an object having a significant height, such as a refrigerator, the shank 120 extending upwards at about 90° and the refrigerator may be located at a 45° to the anchor 100 and the lashing means 110 may be rotated 45° until parallel with the surface of the refrigerator it is extending over. Further, when securing an object has a slight height, such as a mattress, the shank 120 may extend upwards at about 40° and the lashing means 110 may rotate 90° so that the lashing means 110 is parallel to the mattress. In yet another example, the anchor 100 may secure a boat to a dock, and the angles of the shank 120 and lashing means 110 may change during use. It is contemplated that an embodiment wherein the shank 120 is flexible and means 110 is configured to rotate may allow for optimal securement to the anchor 100. Such an embodiment may, for example, and without limitation allow for connection of an object located at about 40°, 45°, 60°, 75°, or 90° to the anchor. A person of ordinary skill will appreciate that the above angles are provided for example only and any angle may be used.

The locking means 130 may comprise an adjustment means 132 and at least one stopper 134a and 134b. The locking means 130 may be operative to allow the anchor 100 to securely attach to the structure 400, thus locking the anchor 100 in place. In the embodiment shown in FIG. 1, the adjustment means 132 may surround substantially all the shank 120. However, in another embodiment, the adjustment means 132 may extend over less than the entire length of the shank 120. For example, the adjustment means 132 may have a length from about 1 inch to about 14 inches. In a further example, the adjustment means 132 may have a length from about 3 inches to about 9 inches. In yet a further example, the adjustment means 132 may have a length of about 6 inches.

It is contemplated that the adjustment means 132 may allow the anchor 100 to removably couple with the plurality of structure. For example, the depth of the opening on decking as a structure may be greater than the depth of the opening on mesh flooring, thus the adjustment means 132 may allow for the anchor 100 to removably secure with the plurality of structures, depending only on the length of the shank. For example, and without limitation, the adjustment means 132 may allow the anchor 100 to removably secure to structures having a depth of up to about 14 inches. In a further embodiment, the adjustment means 132 may allow the anchor 100 to removably secure to structures having a depth from about 0.002 inches to about 6 inches. In a certain exemplary embodiment, the adjustment means 132 may allow the anchor 100 to removable secure to structures having a depth from about 3.5 inches to about 1.75 inches.

In some embodiments, the adjustment means 132 may provide support to the shank 120. For example, the shank 120 may be flexible and the adjustment means 132 may be a resilient compression spring surrounding the shank 120. Thus, the adjustment means 132 may create a support structure around the shank 120 causing the shank 120 to extend upwards from the arm 140. It is contemplated that in embodiments where the adjustment means 132 is the resilient compression spring, the adjustment means 132 may self-adjust to secure with structures of varying heights. For example, a force may be applied to the resilient compression spring to compress the spring and allow the arm 140 to pass through the opening 410 on the structure 400, shown in FIGS. 4-5 and the removal of the force may allow the resilient compression spring to self-adjust and lock with the structure 400.

As shown in FIG. 1, the at least one stopper may comprise a first stopper 134a and a second stopper 134b located on opposing ends of the adjustment means 132. The first stopper 134a may be disposed between the adjustment means 132 and the arm 140 and operative to provide a barrier between the structure 400 and the adjustment means 132 when in use, shown in FIG. 5. The first stopper 134a may be a washer, as shown in FIGS. 1-3, however it is contemplated that the first stopper 134a may be any means suitable to provide a barrier. The first stopper 134a may, as non-limiting examples, be a stop crimp, stop spring, or nut. A person of ordinary skill in the art will appreciate that the aforementioned stoppers are provided for example only and any stopper known in the art may be used.

In an exemplary embodiment wherein the first stopper 134a is a washer, the washer may create a uniform surface that contacts the adjustment means 132. For example, when the anchor 100 is secured to wire mesh, the washer may create the uniform surface on the opening of the mesh, thus providing a consistent force to the adjustment means 132. In a further example, as shown in FIG. 5, the washer may extend over the opening 410 defined by gaps between wood slabs, providing the uniform surface over the gaps, and thus consistent force is applied to the adjustment means. It is contemplated that the washer may be any size suitable to extend over openings 410 in the structure 400. For example, the washer may have an outer diameter from about 0.375 inches to about 5.5 inches. Further, the washer may have an outer diameter from about 2 to about 4 inches, more specifically, the washer may have an outer diameter of about 1.5 inches. It is contemplated that the washer may have an inner diameter of any dimensions operative to surround the shank 120.

Returning to FIG. 1, the second stopper 134b may be disposed between the adjustment means 132 and the lashing means 110. As shown in FIGS. 1-3, the second stopper 134b may be a stop crimp, however, it is contemplated that it may be any stopper known in the art. In some embodiments, such as those illustrated in FIGS. 1-3, the second stopper 134b may be a different stopper than the first stopping means 134a. However, in other embodiments, not shown, the first and second stopper may be the same stopper. In certain exemplary embodiments, the first stopper 134a may have a larger outer diameter than the second stopper 134b. However, in some embodiments, not shown, the second stopper may have a larger or equal outer diameter to the first stopper.

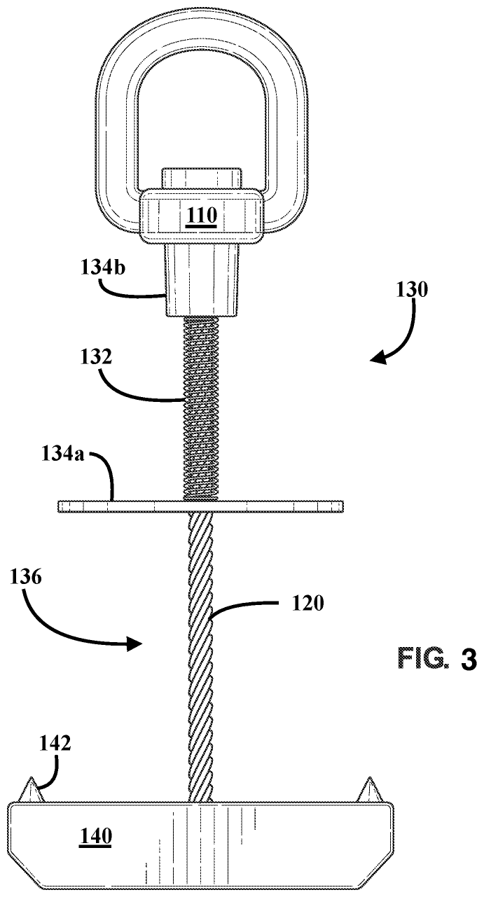

With particular reference to FIG. 3, the adjustment means 132 may be compressed between the first stopper 134a and the second stopper 134b. It is contemplated that a free space 136 may be defined by a length of the shank 120 between the first stopper 134a and the arm 140 when the adjustment means 132 is compressed. The free space 136 may traverse the opening 410 of the structure 400 as shown in FIGS. 4-5. In some embodiments, the free space 136 may be equal to the depth of the structure 400 the anchor 100 is secured to. Thus, the free space 136 may be operative to vary in length depending on the depth of the structure 400. For example, the anchor 100 may be configured to connect to structures 400 having a depth of less than about 12 inches and thus the free space 136 may be have a length of up to about 12 inches. In a further example, the anchor 100 may be configured to connect to structures 400 having a depth of less than about 1.625 inches and thus the free space 136 may have a length of up to about 1.625 inches.

The arm 140 may disposed at the second end of the shank 120 and may be any means suitable to secure the anchor 100 to the structure 400. As shown in an embodiment illustrated in FIGS. 1-4, the arm 140 may be a bar. However, in other embodiments, the arm 140 may be a beam, a rod, or any form suitable to secure the anchor 100. In some embodiments, the arm 140 may have a width of any size suitable to pass through the opening 410 of the structure 400. For example, the arm 140 may have a width less than or equal to about 1 inch. In a further example, the arm 140 may have a width from about 0.125 inches to about 0.5 inches. In an embodiment, the arm 140 may have a width of about 0.25 inches.

In further embodiments, the arm 140 may have any length greater than the width of the arm 140 and operative to extend over the opening 410 in the structure 400. In some embodiments, the arm 140 may have a length greater than or equal to about 0.5 inches. The arm 140, in another embodiment, may have a length from about 1 inch to about 4 inches. In yet another embodiment, the arm 140 may have a length of about two inches. However, a person of ordinary skill will appreciate that these embodiments are provided for example and any length suitable to extend

The arm may 140 may have a height suitable to prevent deformation of the arm 140 caused by force applied from pulling the shank 120. For example, the arm 140 may have a height from about 0.025 inches to about 5 inches. In a further example, the arm 140 may have a height from about 0.75 to about 2 inches, specifically from about 1 to about 1.25 inches. A person of ordinary skill in the art will appreciate that the above dimensions are provided for example only, and any dimensions suitable to practice the invention may be utilized.

The arm 140 may comprise a rigid material, for example, plastic, metal, and composite. In some embodiments, the arm 140 may be made of the same material as the shank 120. In certain exemplary embodiments, the arm 140 and the shank 120 may both comprise stainless steel. However, in other embodiments, the arm 140 and the shank 120 may be made of different materials.

As shown in FIG. 4, the arm 140 may comprise a gripping means 142 disposed on a surface of the arm 140 that contacts the structure 400 when in use. The gripping means 142 may operative to increase the securement of the arm 140 with the structure 400. It is contemplated that the gripping means 142 may reduce movement of the arm 140 by increasing the friction between the arm 140 and the structure 400. The gripping means 142 may, as non-limiting examples, be at least one spike, grit, or other means to increase friction. As shown in the exemplary embodiments of FIGS. 1-4, the gripping means 142 may comprise two spikes disposed on opposite ends of the arm 140. However, it is contemplated that any number of spikes may be used, for example and without limitation, four, six, eight, or ten spikes. It is contemplated that it may be advantageous to use an even number of spikes to provide uniform securement to the structure 400, however, an odd number of spikes may be used. Further, in some embodiments, the at least one spike may be disposed at any point along the surface of the arm 140 that contacts the structure 400 when in use.

In one embodiment, the shank 120 may terminate at a midpoint of the arm 140. In a further embodiment, the gripping means 142 may be uniformly distributed about the center point. In some embodiment, as shown in FIG. 1, the gripping means 142 may be disposed on the arm 140 such that the first stopper 134a may rest between the gripping means 142. It is contemplated that this may further secure the anchor to the structures by dispersing any forces applied to the arm over a relatively large surface area of the surface.

To secure the anchor 100 to the structure 400, as shown in FIGS. 4-5, the arm 140 may be located on a bottom surface 402 and the lashing means 110 and locking means 130 may be located on top surface 402 and the shank 120 may traverse the structure 400. It is contemplated that the arm 140 passes through the opening 410 of the structure to engage with the bottom surface 402. The arm 140 when secured to the structure 400 may extend over the opening 410 to contact two sides of the opening 410. For example, when the structure 400 is decking, as shown in FIGS. 4-5, the arm 140 may extend over the gap between and contact two decking boards. In a further example, not shown, when the structure is wire mesh the arm may extend over the opening of and contact at least two sides of the opening in the mesh. It is further contemplated, that when the structure is a mesh fencing, the at least one stopper may provide the uniform surface on the top surface of the chain.

The arm 140 may be removed from the structure 400 by the application of a downward force on the anchor 100 causing a gripping means 142 to disengage with the structure, the arm 140 may then be rotated to align with the opening 410 and moved upwards to pass through the opening 410. In some embodiments, the downward force may be applied to the at least one stopper 134 disposed on an end of the resilient compression spring to compress the adjustment means 132 and allow for the arm 140 to disengage from the structure 400. Additionally, it is contemplated that force being applied to the lashing point 110 or the shank 120 may cause the arm 140 to disengage from the structure 140.

In some embodiments, as shown in FIG. 5, the second stopper 134b may be adjusted to provide additional securement of the locking means 130. For example, when the adjustment means 132 is the resilient compression spring, the second stopper 134b may allow manual compression of the adjustment means 132 against the first stopper 134a. It is contemplated that this may prevent the first stopper 134a from disengaging from the structure 400 during use.

In the embodiment illustrated in FIG. 5, the adjustment means 132 may be compressed to a length equal to a solid height of the resilient compression spring. However, in some embodiments, not shown, the only force acting on the resilient compression spring when in use may be a force, either directly or indirectly, from the structure. It is contemplated that the force acting indirectly on the adjustment means may be at least one stopper disposed between an end of the adjustment means and the structure.

In one embodiment, the connection means 412 may extend over the object and connect a plurality of the anchors 100 to each other. In another embodiment, the connection means 412 may connect the anchor 100 to a connection site (not shown) on the structure 400. In another embodiment, the connection means 412 may directly connect the object to the anchor 100. In yet a further embodiment, the connection means 412 may be the object.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### Conclusions, Ramifications, and Scope

While certain embodiments of the invention have been illustrated and described, various modifications are contemplated and can be made without departing from the spirit and scope of the invention. For example, a strap comprising two anchors permanently attached to the ends of the strap is contemplated. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the quick tie down anchor with which that terminology is associated. In general, the terms used in the following claims should not be constructed to limit the quick tie down anchor to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the quick tie down anchor is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the quick tie down anchor.

What is claimed is:

1. An anchor comprising:
a shank having a first end and a second end;
a lashing means pivotably disposed on the first end of the shank;
an arm disposed on the second end of the shank; and
a locking means disposed along the length of the shank, between the first end and the second end of the shank, such locking means operative to removably and securely engage the arm with a structure.

2. The anchor of claim 1, wherein the lashing means is a swivel shackle.

3. The anchor of claim 1, wherein the lashing means is a swivel loop.

4. The anchor of claim 1, wherein the arm further comprises a gripping means.

5. The anchor of claim 4, wherein the gripping means is at least one spike on an upper surface of the arm.

6. The anchor of claim 1, wherein the locking means comprises an adjustment means and at least one stopper.

7. The anchor of claim 6, wherein the at least one stopper is disposed at an end of the adjustment means.

8. The anchor of claim 6, wherein the at least one stopper is two stoppers located at opposing ends of the adjustment means.

9. The anchor of claim 6, wherein the at least one stopper is selected from a group consisting of a washer, stop crimp, stop resilient compression spring, nut, and combinations thereof.

10. The anchor of claim 6, wherein the adjustment means is a resilient compression spring.

11. The anchor of claim 1, wherein the shank is flexible.

12. The anchor of claim 1, wherein the shank comprises a rugged cable.

13. The anchor of claim 1, wherein the lashing means is configured to receive a connection means.

14. The anchor of claim 11, wherein the connection means is selected from a group consisting of a strap, carabiner, clip, rope, hook, and combinations thereof.

15. The anchor of claim 1, wherein the arm defines a rectangular cross section, the width of the arm is up to about ¼ inch and the length is up to about 2 inches.

16. An anchor comprising:
a shank having a first end and a second end;
a lashing means pivotably disposed on the first end of the shank;
an arm having a width up to about ¼ inch and a length up to about 2 inches disposed on the second end of the shank comprising at least one gripping means; and
a locking means comprising at least one stopper and a resilient compression spring, the locking means distributed between the first end and the second end of the shank and operative to removably engage the arm with a structure.

17. The anchor of claim 16, wherein the anchor comprises stainless steel.

18. The anchor of claim 16, wherein the at least one stopper comprises two stoppers located at opposite ends of the resilient compression spring.

19. The anchor of claim 16, wherein the arm is a bar operative to engage an underside of the structure.

20. The anchor of claim 19, wherein the at least one gripping means is two spikes disposed on a midline on a surface of the operative to engage the underside of the structure defined by the shank.
